(19) United States
(12) Patent Application Publication
(10) Pub. No.: US 2016/0341875 A1
(43) Pub. Date: Nov. 24, 2016

(54) BACKLIGHT MOUDLE AND LCD DEVICE WITH THE BACKLIGHT MODULE

(71) Applicant: Shenzhen China Star Optoelectronics Technology Co. Ltd., Shenzhen, Guangdong (CN)

(72) Inventors: Jianyu CHANG, Shenzhen, Guangdong (CN); Hu HE, Shenzhen, Guangdong (CN); Qian CAO, Shenzhen, Guangdong (CN); Yong FAN, Shenzhen, Guangdong (CN); Sheng-jer CHANG CHIEN, Shenzhen, Guangdong (CN); Zuoyuan QIN, Shenzhen, Guangdong (CN)

(73) Assignee: Shenzhen China Star Optoelectronics Technology Co. Ltd., Shenzhen, Guangdong (CN)

(21) Appl. No.: 14/429,854

(22) PCT Filed: Jan. 21, 2015
(86) PCT No.: PCT/CN2015/071186

§ 371 Date: Mar. 20, 2015

(30) Foreign Application Priority Data
Dec. 30, 2014 (CN) 201410842923.1

(51) Int. Cl. F21V 8/00

(52) U.S. Cl. CPC G02B 6/0026; G02B 6/0068; G02B 6/0073

(57) ABSTRACT

A backlight module is disclosed, which comprises a light guide plate having at least one incident light side; a light bar, adjacent to the incident light side; a plurality of quantum dot films, the quantum dot films are arranged between the light bar and the incident light side; wherein the light from the light bar goes through the quantum dot film and irradiates on the incident light side. A LCD device with the backlight module is further disclosed. A plurality of shorter quantum dot films are arranged between the light source and the incident light side of the light guide to replace one longer quantum dot film of the conventional art. And the manufacturing process of the short quantum dot film is simple with low cost, and the film does not have the rupturing issue to improve the safety and reliability of the quantum dot film.

### FIELD OF THE INVENTION

The present invention relates to a LCD technology field; specifically, to a backlight module and a LCD device with the backlight module which can prevent a quantum dot film from being broken and chroma consistency of an incident light side of a light guide plate.

### BACKGROUND OF THE INVENTION

With the development of information society, the demand for flat panel displays has been rapid growth. A LCD with some advantages such as small size, low power consumption, no radiation and so on has occupied the dominant position in the current flat panel display market. The LCD device generally comprises a LCD panel and a backlight module disposed relative to the LCD panel, where because the LCD panel cannot generate light by itself, it has to use the back light provided by the backlight module to show images.

In the conventional liquid crystal displays, usually white LED as a backlight to achieve the desired LCD backlit by the light guide plate with a reasonable and optical diaphragm. As people of high color gamut, high color saturation, energy-saving lamps have become increasingly demanding, the current implementation backlight white light source, high color gamut, high color saturation of the programs are: the use of ultraviolet LED with the RGB phosphors; with the use of red, green and blue LED phosphors; the use of blue LED plus plus red LED, a green LED. These methods can increase the color gamut, but difficult to implement, and cost is high.

A quantum dot is a nanocrystal made of semiconductor materials that confine their electron in certain range, and is constituted by super small compound crystal. The quantum dot technology can uses different size crystal to control the wavelength of light, further to control the color accurately. Therefore, the quantum dots (Quantum Dot, QD) materials are used in the backlight module, the use of high spectrum light (e.g., blue LED) to replace the conventional white LED light source, the quantum dot material in the high-frequency irradiation of the light source can be excited to produce different the wavelength spectrum by adjusting the size of the quantum dot material, the color of the synthesized light can be adjusted to achieve the requirements of high color gamut backlight liquid crystal display.

FIG. 1 is a conventional backlight module adapting a quantum dot film. Please refer to FIG. 1. The blue LED 11 is disposed at an incident light side 121 of a light guide plate 121. Quantum dots are packaged into a film to form a quantum dot film 13, where the quantum dot film is disposed between the blue LED 11 and the incident light side of the light guide plate 12. The blue light emitting from the blue LED 11 irradiates the incident light side of the light guide 12 to achieve the white back light of the backlight. However, using this method, the manufacture process of the quantum dot film 13 is complicated with the high cost, and because the quantum dot film 13 is thin, the film has the rupturing issue easily when it is long.

### SUMMARY OF THE INVENTION

In light of the problems existing in the conventional art, An aim of the present invention is to provides A backlight module, wherein, comprising: a light guide plate, having at least one incident light side; a light bar, disposed adjacent to the incident light side; a plurality of quantum dot films, the plurality of quantum dot films arranged between the light bar and the incident light side; wherein light emitted from the light bar through the quantum dot films is irradiated onto the incident light side.

Further, the quantum dot film comprises an effective area and an ineffective area, wherein the ineffective area of each of the quantum dot films faces the effective area of the adjacent quantum dot film.

Further, the light bar comprises a plurality of first light sources and a plurality of second light sources being arranged at intervals wherein each of the first light sources faces the relative effective area of the quantum dot film and each of the second light sources faces the relative ineffective area of the quantum dot film.

Further, the first light source is a blue light emitting diode, and the second light source is a white light emitting diode.

Further, the quantum dot films are attached onto the incident light side.

The other aim of the present invention is to provide a LCD device, comprising a backlight module and a LCD panel disposing relative to the backlight module, the backlight module provides light for the LCD panel so that the LCD panel displays images, wherein the backlight module comprises: a light guide plate, having at least one incident light side; a light bar, disposed adjacent to the incident light side; a plurality of quantum dot films, the plurality of quantum dot films arranged between the light bar and the incident light side; wherein light emitted from the light bar through the quantum dot films is irradiated onto the incident light side.

Further, the quantum dot film comprises an effective area and an ineffective area, wherein the ineffective area of each of the quantum dot films faces the effective area of the adjacent quantum dot film.

Further, the quantum dot film comprises an effective area and an ineffective area, wherein the ineffective area of each of the quantum dot films faces the effective area of the adjacent quantum dot film.

Further, the first light source is a blue light emitting diode, and the second light source is a white light emitting diode.

Further, the quantum dot film area attached onto the incident light side.

The present invention arranges a plurality of shorter quantum dot films between the light source and the incident light side of the light guide to replace one longer quantum dot film of the conventional art. And the manufacturing process of the short quantum dot film is simple with low cost, and the film does not have the rupturing issue to improve the safety and reliability of the quantum dot film. Further, the present invention uses a light source facing the ineffective area of each of the quantum dot films as a while LED so that the incident light side 11 of the light guide plate 110 forms white distribution having chroma consistency to enhance the optical taste of the backlight module 100.

### BRIEF DESCRIPTION OF THE DRAWINGS

The following description in conjunction with the accompanying drawings, the above and other aspects, features and advantages of embodiments of the present invention will become apparent from the drawings in which:

FIG. 1 is a backlight module of the conventional quantum dot film.

FIG. 2 is a schematic view of a LCD device according to the embodiment of an present invention

FIG. 3 is a schematic side view of a backlight module according to an embodiment of the present invention.

FIG. 4 is a top schematic view of a backlight module according to an embodiment of the present invention.

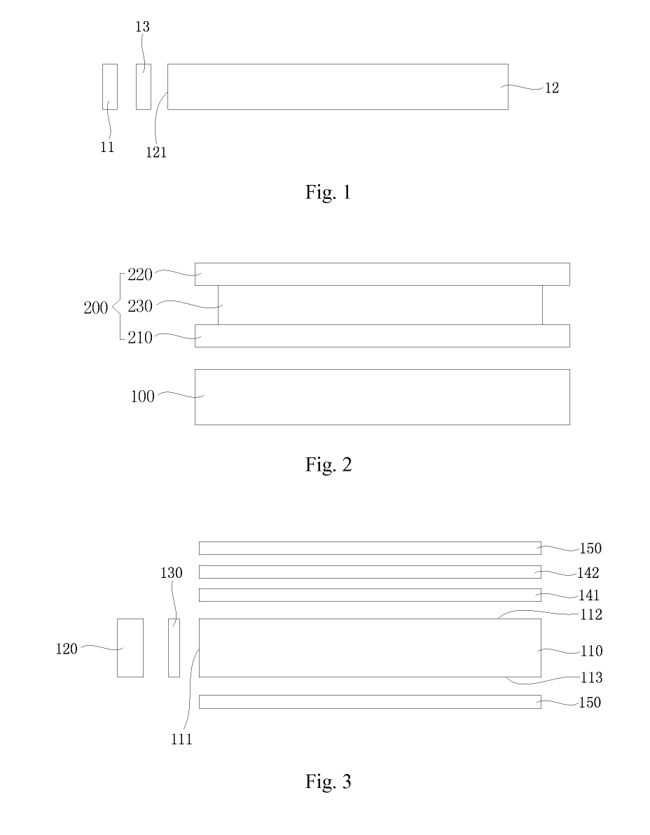

### DETAILED DESCRIPTION OF THE PREFERRED EMBODIMENTS

Hereinafter, embodiments of the present invention will be described in detail with reference to the accompanying drawings. However, be in many different forms and embodiments of the present invention, and the present invention should not be construed as limited to the specific embodiments set forth herein. Rather, these embodiments are provided to explain the principles of the invention and its practical application so that others skilled in the art to understand the invention for various embodiments and various modifications suited to the particular intended application

FIG. 2 is a schematic view of a LCD device according to the embodiment of an present invention.

Please refer to FIG. 2. The LCD device comprises a LCD panel 200 and a backlight module 100 disposed relative to the LCD panel 200, where the backlight module 100 provides light for the LCD panel 200 so that the LCD panel 200 displays images.

The LCD panel 200 generally comprises a TFT (Thin Film Transistor) array substrate 210, a CF (Color Filter) substrate disposed relative to the TFT array substrate 220, and a LC layer 230 disposed between the TFT array substrate 220 and the CF substrate 220, where the LC layer comprises a plurality of liquid crystal molecules. Because the specific structure of the LCD panel 200 of the instant embodiment is basically same as the conventional LCD panel, it is not described in detail herein.

In the following paragraph, the specific structure of the backlight 100 according to an embodiment of the present invention is narrated in detail.

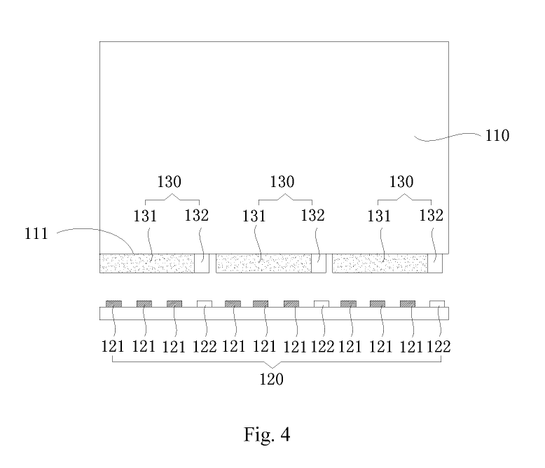

FIG. 3 is a schematic side view of a backlight module according to an embodiment of the present invention. FIG. 4 is a top schematic view of a backlight module according to an embodiment of the present invention.

Refer to FIG. 3. The backlight module 100 based on one embodiment of the present invention comprises a light guide plate 110, a light bar, three quantum dot films 130, a first brightening film 141 and a second brightening film 142, a diffusion film 150 and a reflective film 160. However, the amount of the quantum dot films 130 can be adjusted based on the practical use without being limited by FIG. 3.

Specifically, the light guide plate comprises an incident light side 111, an emitting light side 112, and a bottom side 113. The light bar 120 is disposed adjacent to the incident light side 111 of the light guide plate 110. The three quantum dot films 130 are arranged at intervals between the light bar 120 and the incident light side 111 of the light guide 110, wherein light from the light bar 120 after going through the three quantum dot films 130 is irradiated onto the incident light side 111 of the light guide 110. The first brightening film 141, the second brightening film 142 and the diffusion film 150 is arranged in order on the emitting light side 112 of the light guide 110, where the first brightening film 141 and the second brightening film 142 are used for gathering the light emitting from the emitting light side 112 for improving the luminance of the emitting light side 112. The diffusion film 150 is used for improving the luminance of the upward light which goes through the first brightening film 141 and the second brightening film 142, and improving the soft BCH of the light after going through the first brightening film 141 and the second brightening film 142, such that a uniform surface light source is provided for the LCD panel 200. The reflective film 160 is disposed under the bottom side of the light guide 110 and used to reflect light from the bottom face of the light guide plate 110 into the light guide plate 110 for offering the light utility in the light guide plate 110.

Therefore, the three shorter quantum dot films 130 are arranged at intervals and disposed between the light bar 120 and the emitting light side 111 of the light guide plate 110 and the three shorter size quantum dot film 130 is used instead of the one longer size quantum dot film of the conventional art. Moreover, the shorter quantum dot film 130 has advantages such as simple manufacturing, low cost, and it is not easy to have the rupturing issue, and it owns high reliability.

Otherwise, according to the quantum dot film 130 of the embodiment of the present invention, an ineffective area 132 is formed in the end of each of the quantum dot films 130 so the quantum dot film 130 of the embodiment of the present invention comprises an effective area 131 and an ineffective area 132, where the effective area 131 means the area has quantum dots and the ineffective area 132 means the area has no quantum dot. It should be understood that when a space with the shorter distance between the two strips of the quantum dot films 130, the ineffective area 132 also comprises the space with the shorter distance.

Because the quantum dot film 130 based on the embodiment of the present invention comprises the effective area 131 and the ineffective area 132, the light bar 120 based on the embodiment of the present invention comprises a first light source 121 and a second light source 122, where the amount of the first light source 121 can be arranged based on the practical use. In the instant embodiment, the amount of the first light source 121 is 9. The amount of the second light source 122 can also be arranged based on the practical use. In the instant embodiment, preferably, the amount of the second light source 122, same as the amount of the ineffective area 132, is 3.

The first light source 121 can be a blue LED with high frequency, but it is not limited by the present invention herein. Through irradiating the quantum dot material in the effective area 131 the quantum dot film by the high frequency blue light LED, the different color is generated by exciting the quantum dot material, so that the white back light is generated for the LCD device. The second light source 122 can be a white LCD, but it is not limited by the present invention herein. The white LED light irradiates the incident light side 111 of the light guide plate 110 through the ineffective area 132 of the quantum dot film 130, so that it can be used as the white back light for the LCD device.

Therefore, the light source relative to the ineffective area 132 of each of the quantum dot film 130 is used as the white LED so that the incident light side 11 of the light guide plate 110 forms white distribution having chroma consistency to enhance the optical taste of the backlight module 100.

Otherwise, based on the embodiment of the present invention, in order to position the quantum dot film 130, preferably the three quantum dot films 130 are attached on the incident light side 111 of the light guide plate 110, but it is not limited by the present invention. The positioning method of three quantum dot films 130 also suits other type of positioning methods.

The above-described embodiments of the invention only, and not to limit the patent scope of the present invention, therefore, the use of all contents of the specification and drawings of the present invention is made equivalent structures or equivalent conversion process, either directly or indirectly in the other the relevant art, are included within the same reason the patent scope of the present invention.

What is claimed is:

1. A backlight module, wherein, comprising:
a light guide plate, having at least one incident light side;
a light bar, disposed adjacent to the incident light side;
a plurality of quantum dot films, the plurality of quantum dot films arranged between the light bar and the incident light side;
wherein light emitted from the light bar through the quantum dot films is irradiated onto the incident light side.

2. The backlight module as claimed in claim 1, wherein the quantum dot film comprises an effective area and an ineffective area, wherein the ineffective area of each of the quantum dot films faces the effective area of the adjacent quantum dot film.

3. The backlight module as claimed in claim 2, wherein the light bar comprises a plurality of first light sources and a plurality of second light sources being arranged at intervals wherein each of the first light sources faces the relative effective area of the quantum dot film and each of the second light sources faces the relative ineffective area of the quantum dot film.

4. The backlight module as claimed in claim 3, wherein the first light source is a blue light emitting diode, and the second light source is a white light emitting diode.

5. The backlight module as claimed in claim 1, wherein the quantum dot films are attached onto the incident light side.

6. The backlight module as claimed in claim 2, wherein the quantum dot film area attached onto the incident light side.

7. The backlight module as claimed in claim 3, wherein the quantum dot film area attached onto the incident light side.

8. The backlight module as claimed in claim 4, wherein the quantum dot films are attached onto the incident light side.

9. A LCD device, comprising a backlight module and a LCD panel disposing relative to the backlight module, the backlight module provides light for the LCD panel so that the LCD panel displays images, wherein the backlight module comprises:
a light guide plate, having at least one incident light side;
a light bar, disposed adjacent to the incident light side;
a plurality of quantum dot films, the plurality of quantum dot films arranged between the light bar and the incident light side;
wherein light emitted from the light bar through the quantum dot films is irradiated onto the incident light side.

10. The LCD device as claimed in claim 9, wherein the quantum dot film comprises an effective area and an ineffective area, wherein the ineffective area of each of the quantum dot films faces the effective area of the adjacent quantum dot film.

11. The LCD device as claimed in claim 10, wherein the quantum dot film comprises an effective area and an ineffective area, wherein the ineffective area of each of the quantum dot films faces the effective area of the adjacent quantum dot film.

12. The LCD device as claimed in claim 11, wherein the first light source is a blue light emitting diode, and the second light source is a white light emitting diode.

13. The LCD device as claimed in claim 9, wherein the quantum dot film area attached onto the incident light side.

14. The LCD device as claimed in claim 10, wherein the quantum dot film area attached onto the incident light side.

15. The LCD device as claimed in claim 11, wherein the quantum dot film area attached onto the incident light side.

16. The LCD device as claimed in claim 12, wherein the quantum dot film area attached onto the incident light side.
